(19) United States
(12) Patent Application Publication
(10) Pub. No.: US 2006/0127242 A1
(43) Pub. Date: Jun. 15, 2006

(54) Turbocharger with removable wheel shrouds and/or removable seals

(76) Inventors: Steve P. Martin, Walnut, CA (US); Christopher D. Meade, Redondo Beach, CA (US)

Correspondence Address: HONEYWELL TURBO TECHNOLOGIES, 23326 HAWTHORNE BOULEVARD, SUITE #200, TORRANCE, CA, 90505, US

(21) Appl. No.: 11/008,517

(22) Filed: Dec. 9, 2004

(51) Int. Cl. F04B 17/00; F04B 35/00; F02B 33/44

(52) U.S. Cl. 417/407; 60/605.1

(57) ABSTRACT

A turbocharger includes compressor and/or turbine end housing(s) and removable compressor and/or turbine shroud portion(s) configured in relation to the compressor and/or turbine wheel(s) such that either or both of the wheels can be removed, after removal of the respective shroud portion(s), without having to remove the respective end housing(s). Additionally or alternatively, a turbocharger includes removable and replaceable compressor and/or turbine seal(s) supported by removable compressor and/or turbine seal plate(s).

### BACKGROUND OF THE INVENTION

The present invention relates to turbochargers.

Turbochargers are used in a variety of applications for boosting the performance of internal combustion engines, including IC engines of substantial power and size such as marine engines used for powering maritime vessels. In these higher-power applications, the turbochargers can be quite large and heavy, as well as expensive. The relatively high cost of such large turbochargers provides an economic incentive to service (e.g., repair and/or replace) individual components of the turbocharger, as opposed to replacing the entire turbocharger when it deteriorates or fails.

The substantial size and weight of the turbochargers, however, tend to make them difficult to service. For instance, a common type of turbocharger design includes removable compressor and turbine end housings surrounding the compressor and turbine wheels. If one of the wheels requires replacing, for example as a result of foreign object damage or fatigue, it is necessary to first unbolt the corresponding end housing from the rest of the turbocharger housing and remove it, before the wheel can be accessed and removed. The end housing in many cases is too large and heavy for an individual worker to handle, and hence an overhead hoist or the like is required. However, the cramped quarters in which many of these turbochargers are installed can make the use of such equipment awkward or impossible. Furthermore, the removal of the heavy end housing can pose a risk of causing further damage to components of the turbocharger.

An additional unfavorable aspect of many existing turbocharger designs relates to the seals that isolate the interior of the center housing, in which the bearing assembly is contained, from the compressor and turbine flow paths.

For example, in some turbochargers the turbine seal is an integral machined part of the center housing.

When the turbine seal fails, the entire center housing must be replaced, at substantial cost. This operation furthermore necessitates the use of a hoist or the like, with the attendant difficulties already mentioned.

### BRIEF SUMMARY OF THE INVENTION

The present invention in a first aspect addresses the above needs and achieves other advantages, by providing a turbocharger that allows either or both of the compressor and turbine wheels to be removed without having to remove the respective end housings. In accordance with one embodiment of the invention, the turbocharger comprises:

a centrifugal compressor comprising a compressor wheel having an outermost peripheral surface defining a maximum outer diameter of the compressor wheel, the compressor wheel including a plurality of arcuate compressor blades each extending generally radially outward from a root to a tip of the blade;

a centrifugal turbine comprising a turbine wheel having an outermost peripheral surface defining a maximum outer diameter of the turbine wheel, the turbine wheel including a plurality of arcuate turbine blades each extending generally radially outward from a root to a tip of the blade;

a rotatable shaft having a first end on which the compressor wheel is mounted and an opposite second end on which the turbine wheel is mounted, the shaft being supported in a bearing assembly; and

a housing containing the bearing assembly and the compressor and turbine wheels, the housing including a compressor end housing defining a volute surrounding the compressor wheel for receiving air compressed by the compressor wheel, the compressor end housing having a radially inner surface defining a minimum inside diameter of the compressor end housing, said minimum inside diameter being greater than the maximum outer diameter of the compressor wheel, and the housing further comprising a compressor shroud portion removably fastened by an fastening arrangement to the compressor end housing and defining an inner shroud surface proximate the tips of the compressor blades. The compressor shroud portion is configured to be removable upon release of the fastening arrangement such that the compressor wheel is removable from the housing while the compressor end housing is still in place.

In another embodiment of the invention, the turbocharger includes a turbine end housing defining a volute surrounding the turbine wheel for receiving exhaust gas and supplying the exhaust gas to the turbine wheel, the turbine end housing having a radially inner surface defining a minimum inside diameter of the turbine end housing, said minimum inside diameter being greater than the maximum outer diameter of the turbine wheel, and the housing further comprising a turbine shroud portion removably fastened by a fastening arrangement to the turbine end housing and defining an inner shroud surface proximate the tips of the turbine blades. The turbine shroud portion is configured to be removable upon release of the fastening arrangement such that the turbine wheel is removable from the housing while the turbine end housing is still in place.

In accordance with a second aspect of the invention, a turbocharger is provided, at one or both of the compressor and turbine ends of the shaft, with a seal plate removably fastened to a center housing of the turbocharger and supporting a seal. Removal of the or each seal plate allows the seal(s) to be replaced without having to replace the costly center housing.

The invention also encompasses turbochargers combining the first and second aspects in various ways.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a sectioned side view of a turbocharger in accordance with one embodiment of the invention.

### DETAILED DESCRIPTION OF THE INVENTION

The present inventions now will be described more fully hereinafter with reference to the accompanying drawings, in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

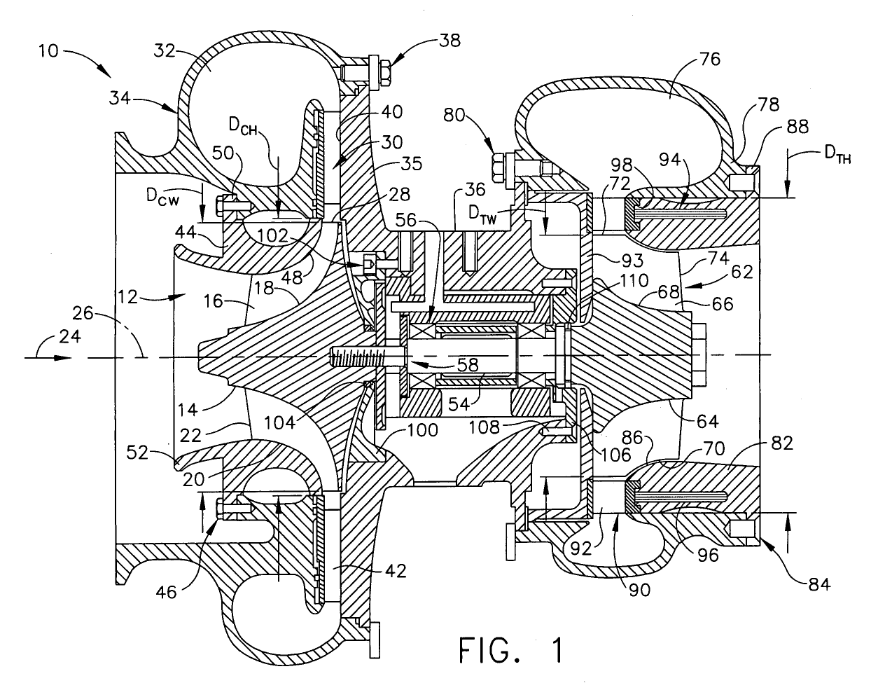

With reference to FIG. 1, a turbocharger 10 representing an embodiment combining the above-noted first and second aspects of the invention is schematically illustrated. The turbocharger 10 includes a centrifugal compressor 12 having a compressor wheel 14 that supports a plurality of compressor blades 16 each of which extends generally radially outwardly from a root 18 to a tip 20 of the blade. Each blade has a leading edge 22 that is encountered by inlet air (indicated by arrow 24) that flows in a generally axial direction (i.e., generally parallel to the longitudinal axis 26 of the turbocharger). Each blade has a trailing edge 28 that is located proximate to, and in some embodiment defines, a maximum outer diameter D_{CW} of the compressor wheel 14. The rotation of the compressor wheel causes the blades 16 to compress the air flowing between the blades and the compressed air is discharged in a generally radially outward direction into a diffuser passage 30.

The diffuser passage 30 diffuses the flow of compressed air and leads the air into a volute 32 that surrounds the compressor wheel. The volute 32 is defined by a compressor end housing 34. The compressor end housing 34 is joined to a backplate 35 that, in the illustrated embodiment, is integrally formed on one end of a center housing 36 of the turbocharger. The compressor end housing 34 can comprise a separate piece from the backplate and be fastened to the backplate by a suitable fastening arrangement 38 as shown. The diffuser passage 30 in the illustrated embodiment is defined between the compressor end housing 34 and a surface 40 of the backplate 35. A guide vane assembly 42 resides in the diffuser passage 30 and functions to facilitate the diffusion of the air (and, in some cases, can also remove swirl from the flow) before it enters the volute 32. The compressor end housing 34 has a minimum inside diameter D_{CH} that is slightly greater than the maximum outer diameter D_{CW} of the compressor wheel 14, for reasons explained below. Although the backplate 35 is shown as being integral with the center housing 36, alternatively the backplate 35 can be separately formed from the center housing and can be affixed to the center housing in any suitable fashion.

The turbocharger also includes a compressor shroud portion 44 that is removably fastened by a fastening arrangement 46 to the compressor end housing 34. The compressor shroud portion 44 is a generally ring-shaped structure having a radially inner shroud surface 48 that is proximate the tips 20 of the compressor blades 16. The compressor flow path is defined between the shroud surface 48 and the hub of the compressor wheel 14. In the illustrated embodiment, the compressor shroud portion 44 defines a generally radially outwardly extending flange 50 and the compressor end housing 34 has a portion configured to abut the flange 50. The flange and the end housing have holes that receive threaded fasteners of the fastening arrangement 46 to attach the shroud portion to the end housing. The shroud portion 44 also can include a tubular portion 52 at its upstream end (relative to the generally axial direction of flow 24) that defines an inlet into the compressor. Any suitable fastening arrangement that is releasable can be used for fastening the compressor shroud portion 44 to the end housing, including threaded fasteners as shown, a clamping mechanism for clamping together respective portions of the shroud portion and end housing, or other types of releasable fastening arrangements.

The compressor wheel 14 is mounted on one end of a shaft 54 that extends through the interior space of the center housing 36. The shaft is rotatably supported by a bearing assembly 56 mounted in the center housing. The compressor wheel is mounted to the shaft by a mounting arrangement 58 in such a manner that the compressor wheel can be detached from the shaft 54 from the compressor side of the center housing. For instance, the shaft can be attached to a threaded stud that passes through a center bore of the compressor wheel and receives a threaded nut to secure the wheel to the stud; however, alternative mounting arrangements for securing the wheel to the shaft can be used, and the invention is not limited in this respect. The important point is that by releasing the mounting arrangement 58, the wheel can be detached from the shaft.

Based on the above description, it will be understood that the provision of the unique compressor end housing 34 and shroud portion 44 enables the compressor wheel 14 to be removed without having to remove the end housing 34. More specifically, releasing the fastening arrangement 46 allows the shroud portion 44 to be removed (to the left in FIG. 1). Then, releasing of the mounting arrangement 58 allows the compressor wheel 14 to be removed from the turbocharger because the maximum diameter of the wheel D_{CW} is less than the minimum inside diameter D_{CH} of the compressor end housing 34. Particularly in turbochargers of substantial size where the end housing can be quite heavy, this ability of the turbocharger provides a significant advantage in ease of servicing of the turbocharger.

The turbocharger 10 also includes a turbine 62 having a turbine wheel 64 that supports a plurality of turbine blades 66 each of which extends generally radially outwardly from a root 68 to a tip 70 of the blade. Each blade has a leading edge 72 that is encountered by inlet air flowing in a generally radially inward direction (i.e., generally perpendicular to the longitudinal axis 26 of the turbocharger) and that is located proximate to, and in some embodiment defines, a maximum outer diameter D_{TW} of the turbine wheel 64. Each blade has a trailing edge 74 that extends generally radially.

A volute 76 that surrounds the turbine wheel and receives exhaust gas from the exhaust stream discharged by an engine (not shown). The volute 76 is defined by a turbine end housing 78. The turbine end housing 78 is joined to the opposite end of a center housing 36 from the compressor 12, and can comprise a separate piece from the center housing and be fastened to the center housing by a suitable fastening arrangement 80 as shown. The turbine end housing 78 has a minimum inside diameter D_{TH} that is greater than the maximum outer diameter D_{TW} of the turbine wheel 64, for reasons explained below.

The turbocharger also includes a turbine shroud portion 82 that is removably fastened by a fastening arrangement 84 to the turbine end housing 78. The turbine shroud portion 82 is a generally ring-shaped structure having a radially inner shroud surface 86 that is proximate the tips 70 of the turbine blades 66. The turbine flow path is defined between the shroud surface 86 and the hub of the turbine wheel 64. In the illustrated embodiment, the turbine shroud portion 82 defines a generally radially outwardly extending flange 88 and the turbine end housing 78 has a portion configured to abut the flange 88. The flange and the end housing have holes that receive threaded fasteners to attach the shroud portion to the end housing.

The turbine also includes a nozzle ring 90 that supports vanes 92 for regulating the exhaust gas flow from the volute 76 into the turbine wheel 64, and for more-efficiently directing the exhaust gas flow into the turbine wheel relative to a nozzleless turbine stage. The nozzle ring essentially comprises a pair of axially spaced rings having the vanes 92 connected therebetween and spaced apart about the circumference of the ring. The nozzle ring 90 is retained between the shroud portion 82 and the turbine heat shield 93. The heat shield can define a radially outwardly facing step at a diameter corresponding to an inside diameter of the nozzle ring such that the step locates the nozzle ring coaxially with respect to the turbocharger axis 26. The nozzle ring is removably connected to the turbine shroud portion 82 by a suitable arrangement 94. For example, as shown, the arrangement 94 can comprise a generally tubular deformable element 96 (e.g., a metal tube or column) that fits into an annular channel formed in the shroud portion and that is axially compressed into the channel by advancing the nozzle ring and shroud portion toward each other such that the element buckles in the channel. One end of the deformable element 96 projects out from the shroud portion and fits into a groove 98 in the nozzle ring. The element 96 exerts a biasing force axially against the nozzle ring to load the nozzle ring against the heat shield 93, preventing or at least substantially reducing any tendency of the nozzle ring to experience looseness or vibration.

The turbine wheel 64 is mounted on the opposite end of the shaft 54 from the compressor wheel, and can be either separately formed from and then joined to the shaft (e.g., by a fastener or by welding or the like) or can be integrally formed with the shaft as one piece. When the mounting arrangement 58 securing the compressor wheel to the shaft is released, the turbine wheel 64 and shaft 54 are free to be withdrawn from the turbocharger housing as a unit.

Based on the above description, it will be understood that the provision of the unique turbine end housing 78 and shroud portion 82 enables the turbine wheel 64 to be removed without having to remove the end housing 78. More specifically, releasing the fastening arrangement 84 allows the shroud portion 82 to be removed (to the right in FIG. 1). Then, releasing of the mounting arrangement 58 securing the compressor wheel to the shaft allows the turbine wheel 64 and shaft 54 to be removed from the turbocharger because the maximum diameter of the wheel D_{TW} is less than the minimum inside diameter D_{TH} of the turbine end housing 78. Particularly in turbochargers of substantial size where the end housing can be quite heavy, this ability of the turbocharger provides a significant advantage in ease of servicing of the turbocharger.

Next, the second aspect of the invention will be explained. Generally, there is a need to seal the interior of the center housing 36, where the bearing assembly 56 resides, from the compressor and turbine flow paths. To this end, the turbocharger 10 includes seal arrangements that advantageously are removable and replaceable at modest cost. More particularly, on the compressor side, the turbocharger includes a compressor seal plate 100 that is disposed between the compressor wheel 14 and the center housing 36, and is fastened to the center housing in a removable fashion by a suitable fastening arrangement 102 such as threaded fasteners or the like. The compressor seal plate 100 is a generally annular structure defining a radially inner surface encircling and coaxial with the turbocharger longitudinal axis 26, and the radially inner surface bears against a seal ring 104 such as a piston ring or the like. The seal ring 104 bears against a rotating surface of the compressor rotor assembly as shown, thus substantially isolating the compressor flow path from the interior of the center housing.

Advantageously, once the compressor wheel 14 has been removed as previously described, the seal plate 100 can be removed by releasing the fastening arrangement 102, and the seal ring 104 can be replaced with a new one if necessary.

A similar removable seal arrangement is provided on the turbine side. More specifically, the turbocharger includes a turbine seal plate 106 that is disposed between the turbine wheel 64 and the center housing 36, and is fastened to the center housing in a removable fashion by a suitable fastening arrangement 108 such as threaded fasteners or the like. The turbine seal plate 106 is a generally annular structure defining a radially inner surface encircling and coaxial with the turbocharger longitudinal axis 26, and the radially inner surface bears against a seal ring 110 such as a piston ring or the like. The seal ring 110 bears against a rotating surface of the turbine rotor assembly as shown, thus substantially isolating the turbine flow path from the interior of the center housing.

Advantageously, once the turbine wheel 64 has been removed as previously described, the seal plate 106 can be removed by releasing the fastening arrangement 108, and the seal ring 110 can be replaced with a new one if necessary.

As noted, although the turbocharger 10 as illustrated incorporates both the first aspect of the invention relating to the removable shroud portions 44, 82, as well as the second aspect of the invention relating to the removable seal plates 100, 106 and seals 104, 110, in alternative embodiments (not illustrated), a turbocharger can include only the turbine end or compressor end removable shrouds of the first aspect, or only turbine end or compressor end seals of the second aspect.

The invention in its various aspects facilitates maintenance and service work on turbochargers by making it easier and less-costly to remove and replace the compressor and/or turbine wheels, and to remove and replace the compressor and/or turbine seals.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A turbocharger, comprising:
a centrifugal compressor comprising a compressor wheel having a maximum outer diameter, the compressor wheel including a plurality of compressor blades each extending generally radially outward from a root to a tip of the blade;
a centrifugal turbine comprising a turbine wheel having a maximum outer diameter, the turbine wheel including a plurality of turbine blades each extending generally radially outward from a root to a tip of the blade;
a rotatable shaft having a first end on which the compressor wheel is mounted and an opposite second end on which the turbine wheel is mounted, the shaft being supported in a bearing assembly; and
a housing containing the bearing assembly and the compressor and turbine wheels, the housing including a compressor end housing defining a volute surrounding the compressor wheel for receiving air compressed by the compressor wheel, the compressor end housing having a radially inner surface defining a minimum inside diameter of the compressor end housing, said minimum inside diameter being greater than the maximum outer diameter of the compressor wheel, and the housing further comprising a compressor shroud portion removably fastened by a fastening arrangement to the compressor end housing and defining an inner shroud surface proximate the tips of the compressor blades, the compressor shroud portion being configured to be removable upon release of the fastening arrangement such that the compressor wheel is removable from the housing while the compressor end housing is still in place.

2. The turbocharger of claim 1, wherein the housing includes a center housing that defines a cavity containing the bearing assembly, and further comprising a compressor seal plate that seals against a removable compressor seal that seals against a rotating surface to substantially isolate the cavity of the center housing from the compressor, wherein the compressor seal plate is removably fastened to the center housing by a fastening arrangement, whereby the compressor seal plate and removable compressor seal are removable and replaceable.

3. The turbocharger of claim 1, wherein the housing includes a turbine end housing defining a volute surrounding the turbine wheel for receiving exhaust gas and supplying the exhaust gas to the turbine wheel, the turbine end housing having a radially inner surface defining a minimum inside diameter of the turbine end housing, said minimum inside diameter being greater than the maximum outer diameter of the turbine wheel, and the housing further comprising a turbine shroud portion removably fastened by a fastening arrangement to the turbine end housing and defining an inner shroud surface proximate the tips of the turbine blades, the turbine shroud portion being configured to be removable upon release of the fastening arrangement such that the turbine wheel is removable from the housing while the turbine end housing is still in place.

4. The turbocharger of claim 3, wherein the housing includes a center housing that defines a cavity containing the bearing assembly, and further comprising a turbine seal plate that seals against a removable turbine seal that seals against a rotating surface to substantially isolate the cavity of the center housing from the turbine, wherein the turbine seal plate is removably fastened to the center housing by a fastening arrangement, whereby the turbine seal plate and removable turbine seal are removable and replaceable.

5. The turbocharger of claim 3, wherein the housing includes a center housing containing the bearing assembly, and wherein the turbine end housing is separately formed from the center housing and is fastened to the center housing by a releasable fastening arrangement.

6. The turbocharger of claim 1, wherein the housing includes a center housing containing the bearing assembly, and wherein the compressor end housing is separately formed from the center housing and is fastened to the center housing by a releasable fastening arrangement.

7. The turbocharger of claim 1, wherein the housing includes a center housing to which the compressor end housing is joined such that a diffuser passage is defined between the center housing and the compressor end housing, the diffuser passage leading generally radially outwardly from the compressor wheel into the volute defined by the compressor end housing.

8. A turbocharger, comprising:
a centrifugal compressor comprising a compressor wheel having a maximum outer diameter, the compressor wheel including a plurality of compressor blades each extending generally radially outward from a root to a tip of the blade;
a centrifugal turbine comprising a turbine wheel having a maximum outer diameter, the turbine wheel including a plurality of turbine blades each extending generally radially outward from a root to a tip of the blade;
a rotatable shaft having a first end on which the compressor wheel is mounted and an opposite second end on which the turbine wheel is mounted, the shaft being supported in a bearing assembly; and
a housing containing the bearing assembly and the compressor and turbine wheels, the housing including a turbine end housing defining a volute surrounding the turbine wheel for receiving exhaust gas and supplying the exhaust gas to the turbine wheel, the turbine end housing having a radially inner surface defining a minimum inside diameter of the turbine end housing, said minimum inside diameter being greater than the maximum outer diameter of the turbine wheel, and the housing further comprising a turbine shroud portion removably fastened by a fastening arrangement to the turbine end housing and defining an inner shroud surface proximate the tips of the turbine blades, the turbine shroud portion being configured to be removable upon release of the fastening arrangement such that the turbine wheel is removable from the housing while the turbine end housing is still in place.

9. The turbocharger of claim 8, wherein the housing includes a center housing containing the bearing assembly and joined to the turbine end housing, and further comprising a turbine seal plate that seals against a removable turbine seal that seals against a rotating surface to substantially isolate the cavity of the center housing from the turbine, wherein the turbine seal plate is removably fastened to the center housing by a fastening arrangement, whereby the turbine seal plate and removable turbine seal are removable and replaceable.

10. The turbocharger of claim 9, the housing including a compressor end housing defining a volute surrounding the compressor wheel for receiving air compressed by the compressor wheel, the compressor end housing having a radially inner surface defining a minimum inside diameter of the compressor end housing, said minimum inside diameter being greater than a maximum outer diameter of the compressor wheel, and the housing further comprising a compressor shroud portion removably fastened by an fastening arrangement to the compressor end housing and defining an inner shroud surface proximate the tips of the compressor blades, the compressor shroud portion being configured to be removable upon release of the fastening arrangement such that the compressor wheel is removable from the housing while the compressor end housing is still in place.

11. The turbocharger of claim 8, wherein the turbine seal comprises a seal ring.

12. A turbocharger, comprising:
a centrifugal compressor comprising a compressor wheel including a plurality of compressor blades;
a centrifugal turbine comprising a turbine wheel including a plurality of turbine blades;
a rotatable shaft having a first end on which the compressor wheel is mounted and an opposite second end on which the turbine wheel is mounted, the shaft being supported in a bearing assembly; and
a housing containing the compressor and turbine wheels and including a center housing that defines a cavity containing the bearing assembly, the housing including a turbine end housing defining a volute surrounding the turbine wheel for receiving exhaust gas and supplying the exhaust gas to the turbine wheel, the turbine end housing having a radially inner surface defining a minimum inside diameter of the turbine end housing, the turbine end housing being attached to the center housing, and further comprising a turbine seal plate that seals against a removable turbine seal that seals against a rotating surface to substantially isolate the cavity of the center housing from the turbine, wherein the turbine seal plate is removably fastened to the center housing by a fastening arrangement, the turbine seal plate having a diameter less than the minimum inside diameter of the turbine end housing, whereby the turbine seal plate and removable turbine seal are removable and replaceable while the turbine end housing is attached to the center housing.

13. The turbocharger of claim 12, wherein the turbine seal comprises a seal ring.

14. The turbocharger of claim 12, the housing including a compressor end housing defining a volute surrounding the compressor wheel for receiving air compressed by the compressor wheel, the compressor end housing having a radially inner surface defining a minimum inside diameter of the compressor end housing, the compressor end housing being attached to the center housing, and further comprising a compressor seal plate that seals against a removable compressor seal that seals against a rotating surface to substantially isolate the cavity of the center housing from the compressor, wherein the compressor seal plate is removably fastened to the center housing by a fastening arrangement, the compressor seal plate having a diameter less than the minimum inside diameter of the compressor end housing, whereby the compressor seal plate and removable compressor seal are removable and replaceable while the compressor end housing is attached to the center housing.

15. The turbocharger of claim 14, wherein the compressor seal comprises a seal ring.

16. The turbocharger of claim 14, wherein the fastening arrangement for the compressor seal plate is separate and independent from the fastening arrangement for the turbine seal plate.

17. A turbocharger, comprising:
a centrifugal compressor comprising a compressor wheel including a plurality of compressor blades;
a centrifugal turbine comprising a turbine wheel including a plurality of turbine blades;
a rotatable shaft having a first end on which the compressor wheel is mounted and an opposite second end on which the turbine wheel is mounted, the shaft being supported in a bearing assembly; and
a housing containing the compressor and turbine wheels and including a center housing that defines a cavity containing the bearing assembly, the housing including a compressor end housing defining a volute surrounding the compressor wheel for receiving air compressed by the compressor wheel, the compressor end housing having a radially inner surface defining a minimum inside diameter of the compressor end housing, the compressor end housing being attached to the center housing, and further comprising a compressor seal plate that seals against a removable compressor seal that seals against a rotating surface to substantially isolate the cavity of the center housing from the compressor, wherein the compressor seal plate is removably fastened to the center housing by a fastening arrangement, the compressor seal plate having a diameter less than the minimum inside diameter of the compressor end housing, whereby the compressor seal plate and removable compressor seal are removable and replaceable while the compressor end housing is attached to the center housing.
